(19) United States
(12) Patent Application Publication
(10) Pub. No.: US 2001/0004465 A1
(43) Pub. Date: Jun. 21, 2001

(54) Cereal flour dough sheet-derived food and production process thereof

(75) Inventors: Hiroyuki Sakata, Kanagawa (JP); Chie Sasaki, Kanagawa (JP); Masahiko Nonaka, Kanagawa (JP); Reiko Miyano, Kanagawa (JP); Sumie Sato, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: AJINOMOTO CO., INC., Tokyo (JP)

(21) Appl. No.: 09/737,562

(22) Filed: Dec. 18, 2000

(30) Foreign Application Priority Data
Dec. 17, 1999 (JP) P. HEI. 11-358280

(51) Int. Cl. A21D 6/00; A23C 3/02

(52) U.S. Cl. 426/549; 426/502; 426/283; 426/94

(57) ABSTRACT

A cereal flour dough sheet-derived food, which contains a cereal material-derived water-soluble fraction in a portion of food where deterioration of palatability in texture occurs, said fraction having an equilibrium moisture content of from 10% by weight to 80% by weight at 25° C. and a glass transition moisture of from 1% by weight to 30% by weight at 25° C., and said fraction being contained in an amount of from 0.2% by weight to 50% by weight calculated as the solid content based on the total solid content of said portion. It is possible to provide edible substances capable of effectively inhibiting deterioration of palatability of food which occurs due, for example, to the reduction of moisture during preservation and/or cooking of processed food products and food materials containing various cereal flours, particularly cereal flour dough sheet-derived food products.

### SUMMARY OF THE INVENTION

This invention relates to food and food materials which express and maintain high quality palatability and physical properties for a prolonged period of time, which are obtained by separating a water-soluble fraction having a glass transition moisture of from 1% by weight to 30% by weight at 25° C. from cereal materials (e.g., wheat flour) making use of an industrially easily applicable method, thereafter adding the water-soluble fraction to food and food materials, and to their production process.

### BACKGROUND OF THE INVENTION

Food products, particularly wheat flour products which are preserved and circulated under a frozen or chilled condition, including noodles, dim sums (Chinese snacks) such as gyoza (jiao-zi, a dumpling staffed with minced meat), Shao-mai (Chinese-style steamed meat or shrine dumpling), wonton (a Chinese flour dumpling with meat) and side dishes such as ravioli, lose soft palatability desirable as the skin in many cases during the process of from just after production to preservation or re-cooking (e.g., microwave heating) due to drying and subsequent hardening of hydrated wheat flour as the main. component contained in the skin portion. Prevention of the deterioration of such a palatability in texture has been at serious technological subject in developing processed food including various types of frozen food.

With the aim of solving such a problem, an attempt has been made to inhibit hardening phenomenon of the skin portion caused by microwave oven cooking, for example, by including an edible monovalent metal salt of an acidic amino acid polymer such as polyaspartic acid or polyglutamic acid in the skin portion (JP-A-8-112084; the term “J-A” as used hereain means an “unexamined published Japanese patent application”). However, these substances added in an amount for obtaining sufficient effect have problems which should be further improved for practical use, such as the addition of peculiar taste and flavor to food in the case of the use of a low molecular weight substance and the generation of changes in physical properties such as increased viscosity in food in the case of the use of a high molecular weight substance.

Thus, the present invention is to provide edible substances capable of inhibiting deterioration of palatability of food more effectively than the conventional counterparts, which occurs due, for example, to the reduction of moisture during preservation and/or cooking of processed food and food materials containing various cereal flours typically including wheat flour as the main component, and also contemplates providing food products produced and processed by adding such edible substances.

As a result of extensive studies to solve the above problems, the present inventors found that soft and desirable palatability can be provided to a portion of food where deterioration of palatability in texture occurs due to reduction of moisture, particularly in the skin portion of gyoza, Shao-mai, wonton and ravioli, and the palatability can be maintained during a prolonged period of preservation and/or after cooking process, by isolating a water-soluble fraction having an equilibrium moisture content of from 10% by weight to 80% by weight at 25° C. and a glass transition moisture of from 1% by weight to 30% by weight at 25° C. from a cereal material and adding the water-soluble fraction in a food in a sufficient amount for generating the effect. The present invention includes each of the following inventions.

(1) A food, particularly a cereal flour dough sheet-derived food or a cereal flour dough sheet-derived food material, which contains a cereal material-derived water-soluble fraction in a portion of food where deterioration of palatability in texture occurs, said fraction having an equilibrium moisture content of from 10% by weight to 80% by weight at 25°C. and a glass transition moisture of from 1% by weight to 30% by weight at 25°C., and said fraction being contained in an amount of from 0.2% by weight to 50% by weight, preferably from 1% by weight to 30% by weight, more preferably from 2% by weight to 20% by weight, calculated as the solid content based on the total solid content of said portion.

(2) The food, particularly a cereal flour dough sheet-derived food or a cereal flour dough sheet-derived food material described in the item (1), wherein the cereal material is a part which composes a grain of cereal such as wheat, rye, barley, rice, oat, triticale, corn, sorghum, spelt, buckwheat, millet, japanese millet or soybean, and its processed forms such as chip or powder.

(3) The food, particularly a cereal flour dough sheet-derived food or a cereal flour dough sheet-derived food material described in the item (1) or (2), wherein the food is selected from the group consisting of frozen food and chilled food.

(4) The food, particularly a cereal flour dough sheet-derived food or a cereal flour dough sheet-derived food material described in the item (1), wherein the food is selected from the group consisting of noodles and pastas.

(5) The food, particularly a cereal flour dough sheet-derived food or a cereal flour dough sheet-derived food material described in any one of the items (1) to (4), wherein the food is selected from the group consisting of gyoza, Shao-mai, wonton and ravioli.

(6) The food, particularly a cereal flour dough sheet-derived food or a cereal flour dough sheet-derived food material described in the item (5), wherein the portion of the food where deterioration of palatability in texture occurs is the skin portion of selected from the group consisting of gyoza, Shao-mai, wonton and ravioli.

(7) A process for producing a food, particularly a cereal flour dough sheet-derived food or a cereal flour dough sheet-derived food material, which comprises preparing a dispersion by adding from the equivalent volume to 20 volumes of water to a cereal material and thoroughly stirring and mixing them, allowing the dispersion to stand at a temperature of 70°C. or less for a period of from 30 minutes to 48 hours, subsequently carrying out solid-liquid separation to obtain an aqueous solution containing a water-soluble fraction having an equilibrium moisture content of from 10% by weight to 60% by weight at 25° C. and a glass transition moisture of from 1% by weight to 30% by weight at 25° C., and then adding the water-soluble fraction of the aqueous solution in a portion of food where deterioration of palatability in texture occurs, in an amount of from 0.2% by weight to 50% by weight, preferably from 1% by weight to 30% by weight, more preferably from 2% by weight to 20% by weight, calculated as the solid content based on the total solid content of said portion.

(8) The process for producing a food, particularly a cereal flour dough sheet-derived food or a cereal flour dough sheet-derived food material described in the item (7), wherein the water-soluble fraction of the aqueous solution is included in a portion where deterioration of palatability in texture occurs, in an amount of from 0.2% by weight to 50% by weight calculated as the solid content based on the total solid content of said portion, directly in the form of aqueous solution containing the water-soluble fraction.

(9) The process for producing a food, particularly a cereal flour dough sheet-derived food or a cereal flour dough sheet-derived food material described in the item (6), (7) or (8), wherein an enzyme capable of hydrolyzing water-insoluble materials derived from plant cell wall is added during the step in which an aqueous solution containing a water-soluble fraction is obtained by preparing a dispersion by adding water to a cereal materials and thoroughly stirring and mixing them and then carrying out solid-liquid separation of the dispersion.

(10) The process for producing a food, particularly a cereal flour dough sheet-derived food or a cereal flour dough sheet-derived food material described in any one of the items (6) to (9), wherein the the cereal material is a part which composes a grain of cereal such as wheat, rye, barley, rice, oat, triticale, corn, sorghum, spelt, buckwheat, millet, Japanese millet or soybean, and its processed forms such as chip or powder.

(11) The process for producing a food, particularly a cereal flour dough sheet-derived food or a cereal flour dough sheet-derived food material described in any one of the items (6) to (10), wherein the food is selected from the group consisting of frozen food and chilled food.

(12) The process for producing a food, particularly a cereal flour dough sheet-derived food or a cereal flour dough sheet-derived food material described in any one of the items (6) to (10), wherein the food is selected from the group consisting of gyoza, Shao-mai, wonton and ravioli.

(13) The process for producing a food, particularly a cereal flour dough sheet-derived food or a cereal flour dough sheet-derived food material described in item (10), wherein the portion of the food where deterioration of palatability in texture occurs is the skin portion of selected from the group consisting of gyoza, Shao-mai, wonton and ravioli.

### BRIEF DESCRIPTION OF THE DRAWING

FIG. 1 is a graph showing effect of the addition of a water-soluble fraction derived from soft wheat flour to inhibit hardening phenomenon of cereal flour dough sheet accompanied by its drying.

### DETAILED DESCRIPTION OF THE INVENTION

According to the invention, the cereal materials mainly indicate those which are currently used in the production of various type of food, that is a part which composes a grain of cereals such as wheat, rye, barley, rice, oat, triticale, corn, sorghum, spelt, buckwheat, millet, japanese millet or soybean, and its processed forms such as chip or powder, but include all other edible materials derived from cereals which contain a water-soluble fraction having an equilibrium moisture content of from 10% by weight to 80% by weight at 25° C. and a glass transition moisture of from 1% by weight to 30% by weight at 25° C.

The term “equilibrium moisture content at 25° C.” as used herein means an equilibrium moisture content in a supersaturated water vapor atmosphere at 25° C., which is measured by putting a roughly pulverized freeze-dried material of about 10% by weight solution or suspension of each sample in a desiccator into which supersaturated water vapor at 25° C. is fed at a rate of 1.6 liters/minute, taking out the sample when its weight reached equilibrium after about 20 hours, and then calculating compositional ratio (% by weight) of the moisture in the sample from the change of its weight before and after its drying at 105° C. for 24 hours.

Also, the term “glass transition moisture at 25°C.” as used herein means a moisture value (% by weight) at which a sample changes from glassy state to rubbery state at 25° C., which is calculated from the curve of a moisture-dependency of glass transition temperature, which is prepared based on the results of measurement of glass transition temperature of each sample by differential scanning calorimeter after moisture absorption of a roughly pulverized freeze-dried material of about 10% by weight solution or suspension of each sample to various moisture values using water vapor.

The atmosphere was set at 25° C. in measuring the equilibrium moisture content and glass transition moisture, because processed food products are taken at around room temperature in certain forms such as a box lunch in many cases, and in order to use these values as indices for finding deterioration of palatability in texture of food or food material, such as hardening, under such condition.

The term “cereal flour dough sheet” as used herein means a edible sheet product obtained by kneading cereal flour such as wheat flour, rye flour, barley flour, rice flour, oat flour, triticale flour, corn flour, sorghum flour, buckwheat flour or soybean flour with water and, as the occasion demands, food starches such as corn starch, tapioca starch, potato starch, rice starch, waxy corn starch, sweet potato starch, lotus starch, and their chemically or physically modified products, to form dough having a moisture content of preferably from 20% by weight to 80% by weight, then by stretching the dough using a rolling mill, etc. or by a handwork to have a certain thickness (preferably, less than 10 mm). One can add other food ingredients including seasonings in the above dough preparation. The term “cereal flour dough sheet” as used herein preferably does not include the category of leavened flour dough products such as bread.

The term “cereal flout dough sheet-derived food” as used herein means any kind of food product which possesses the cereal flour dough sheet as an essential part, for example, dim sums (Chinese snacks) such as gyoza (jiao-zi, a dumpling stuffed with minced meat), Shao-mai (Chinese-style steamed meat or shrimp dumpling), wonton (a Chinese flour dumpling with meat) and side dishes such as ravioli. The term “cereal flour dough sheet-derived food” as used herein also means any other food products which are produced by stuffing with, for example, meat, vegetables, fish, shellfish, etc. using cereal flour dough sheet as a skin.

According to the invention, a cereal material which can be used to prepare a water-soluble fraction of the invention is mainly originated from a part of cereal grain (here, cereal grain is, for example, wheat grain, rye grain, barley grain, rice grain, oat grain, triticale grain, corn grain, sorghum grain, spelt grain, buckwheat grain, millet grain, japanese millet grain or soybean grain), but also originated from any other parts of cereal plants, such as stalk and leaf. It is known that a grain of those cereals is mainly composed of husk (such as pericarp, testa), aleurone layer, endosperm, embryo, and so on. Thus, a cereal material of the invention which can be used to prepare a water-soluble fraction is, for example, chaff, wheat bran, rice bran, wheat flour, grease-removed soybean flour, and so on. Each part derived from the cereal grains can be used separately or jointly to prepare a water-soluble fraction. One can also use whole grains of cereals as the origin of a water-soluble fraction of the invention.

According to the invention, a part which composes a cereal grain (here, cereal grain is, for example, wheat grain, rye grain, barley grain, rice grain, oat grain, triticale grain, corn grain, sorghum grain, spelt grain, buckwheat grain, millet grain, japanese millet grain or soybean grain) can be used not only as its intact form but also as its processed forms such as chip or powder, dependent on demands. And before the preparation of a water-soluble fraction, a part which composes a cereal grain can be heated and/or pressurized in the presence of suitable moisture in order to help extraction of a water-soluble fraction.

Regarding an example of the process for separating a water-soluble fraction having an equilibrium moisture content of from 10% by weight to 80% by weight at 25° C. and a glass transition moisture of from 1% by weight to 30% by weight at 25° C. from the cereal material to be used in the invention, an initial step of the process which is used in preparing a large amount of water-soluble pentosan fraction from wheat flour can be cited [e.g., Anne-Lise Faurot et al., Lebensm.-Wiss. U.-Technol., Vol. 28, p. 436 (19) (1995)]. Illustratively, the cereal material to be used is dispersed in from equivalent volume to 20 volumes, preferably from 2 volumes to 10 volumes, more preferably from 3 volumes to 8 volumes, of water and stirred for a period of from 1 minute to 600 minutes using a stirrer equipped with a mixing blade. After the stirring, the dispersion is allowed to stand for a period of from 30 minutes to 48 hours, preferably from 1 hour to 36 hours, more preferably from 6 hours to 24 hours, and then the water-soluble fraction of interest can be obtained by recovering the liquid portion using a solid-liquid separation method which can be carried out industrially and easily, such as decantation or centrifugation. In this connection, in carrying out extraction of the water-soluble fraction and the solid-liquid separation, the water temperature is maintained at 70° C. or less, preferably 60° C. or less, more preferably 50° C. or less.

When the amount of water in which the cereal material is to be dispersed is less than the equivalent volume based on the cereal material, the handling becomes difficult due to high viscosity of the dispersion, and when the amount of water exceeds 20 volumes, the handling thereafter becomes complex due to too large liquid volume, so that such cases are not desirable.

Also, the water-soluble components cannot be extracted sufficiently when the stirring time of cereal material dispersion is less than 1 minute, and the water-soluble components can be extracted sufficiently when the stirring time exceeds 600 minutes but, when the cereal material is wheat flour for example, so-called gluten network is formed by the prolonged period of stirring, which has a possible danger of causing a difficulty in separating the liquid portion, so that such cases are not desirable In addition, the solid-liquid separation cannot be carried out sufficiently when the standing period after stirring is less than 30 minutes, and though the period exceeding 48 hours can effect sufficient solid-liquid separation, it causes a disadvantage of being high in production cost due to too long production time and is not desirable also from the viewpoint of microbial contamination.

In carrying out extraction of water-soluble components and solid-liquid separation, the water temperature exceeding 70° C. is not desirable, because the starch component in the cereal material swells and gelatinizes and causes a difficulty in separating the liquid portion, when the cereal material is wheat flour for example.

It is known that, when the cereal material is wheat flour for example, the water-soluble components of cereal material prepared in this manner contain water-soluble pentosans such as water-soluble arabinoxylan and water-soluble arabinogalactan-peptide as albumen-originated components, water-soluble proteins such as albumin, amino acids, peptides, glycoproteins and minerals [e.g., Y. Pomeranz, The Latest Cereal Science and Technology, Pan News, pp. 161-163 (1992)]. Among these components, it is desirable to contain a large amount of water-soluble pentosans as the cereal material-originated water-soluble components of the invention, and desalting and further purification can be carried out as occasion demands in order to increase the water-soluble pentosan content, but these components may also be used as such in the state of mixture.

It is known that the cereal material contains water-insoluble pentosans in addition to the water-soluble pentosans. Thus, it is possible to increase the content of water-extractable water-soluble pentosans by solubilizing the water-insoluble pentosans through their appropriate hydrolysis with so-called plant cell wall degradable enzymes, such as pentosanase, hemicellulase, by their joint use in preparing the water-soluble fraction of the invention. Although it is dependent on the origin, part, shape of the cereal material, the suitable range of amount of the cell wall degradable enzymes added is from 10 ppm to 10% by weight.

In addition, a component capable of acting upon pentosans oxidatively (e.g., hydrogen peroxide, several oxidative enzyme, such as peroxidase, phenol oxidase) can also be used jointly in order to adjust viscosity of the water extract of cereal material. An important point in using the water-soluble components separated from cereal materials is that the equilibrium water content of the components at 25° C. is from 10% by weight to 80% by weight and the glass transition moisture at 25° C. is from 1% by weight to 30% by weight.

The liquid portion separated in this manner can be used as such in the production of final products, but it can also be used in the form of so-called mixed powder by once drying and then mixed with various side materials. An important point in using the separated liquid portion is that a water-soluble fraction having an equilibrium moisture content of from 10% by weight to 80% by weight at 25° C. and a glass transition moisture of from 1% by weight to 30% by weight at 25° C. is contained in a portion of the final product where deterioration of palatability in texture occurs, in an amount of from 0.2% by weight to 50% by weight calculated as the solid content based on the total solid content of the portion. The reason for this is that it is difficult to obtain stable effects in terms of the expression and keeping of desirable palatability in texture when the content is less than 0.2% by weight and that a problem of causing changes in the taste, flavor and palatability in texture of the final product is generated when the content exceeds 50% by weight. In this connection, the portion where deterioration of palatability in texture occurs corresponds, for example, to the skin portion of gyoza, Shao-mai, wonton and ravioli.

The method for adding the water-soluble fraction of the invention having an equilibrium moisture content of from 10% by weight to 80% by weight at 25° C. and a glass transition moisture of from 1% by weight to 30% by weight at 25° C. to the portion where deterioration of palatability in texture occurs is not particularly limited, and it may be contained in the skin portion by a method in which an aqueous solution of the separated water-soluble fraction is directly added at the time of the production of skin portion, a method in which the water-soluble fraction is dried, pulverized and then uniformly mixed with other food materials which are used to produce skin portion or a method in which the skin portion is soaked in an aqueous solution containing the water-soluble fraction and allowed to stand or pressurized, or a method in which an aqueous solution containing the water-soluble fraction is coated or sprayed on the surface of formed skin portions such as of gyoza, Shao-mai, wonton and ravioli may also be used, and selection of the method is decided by taking necessary factors such as properties of the final product and handling performance into consideration.

The following describes the invention based on examples which, however, do not limit the invention.

### EXAMPLE 1

Preparation of water-soluble fraction from soft wheat flour:

Five liters of water was added to 1 kg of soft wheat flour and stirred for 30 minutes with an stirrer equipped with an mixing blade, and the thus obtained suspension was allowed to stand overnight at 5°C. to effect sedimentation of water-insoluble components. Thereafter, solid-liquid separation of the supernatant was effected by decantation to obtain the water-soluble fraction of interest. This water-soluble fraction was freeze-dried and then pulverized to obtain a white powder (39.8 g). When its equilibrium moisture content and glass transition moisture at 25° C. were measured, the equilibrium moisture content was 33.8% by weight and the glass transition moisture was 8.4% by weight.

### EXAMPLE 2

Preparation of water-soluble fraction from hard wheat flour:

Five liters of water was added to 1 kg of hard wheat flour and the same procedure of Example 1 was carried out to separate the supernatant (water-soluble fraction). The thus obtained water-soluble fraction was freeze-dried and then pulverized to obtain a white powder (53.1 g). When its equilibrium moisture content and glass transition moisture at 25° C. were measured, the equilibrium moisture content was 31.1% by weight and the glass transition moisture was 8.4% by weight.

### EXAMPLE 3

Evaluation of the water-soluble fraction derived from soft wheat flour using cereal flour dough sheet:

The water-soluble fraction derived from soft wheat flour described in Example 1 (freeze-dried and then pulverized) was added in an amount of 0 or 10 parts by weight (0 or 7.2% by weight based on the skin weight) to 100 parts by weight of wheat flour (medium-strength flour), 1 part by weight of sodium chloride and 37.5 parts by weight of water, followed by mixing for 10 minutes, and then the mixture was made into a dough sheet using a noodle making machine. This was rolled and formed into a dough sheet thickness of 0.6 mm and then steamed for 5 minutes using a steamer. Thereafter, the dough sheet was allowed to stand for a predetermined period of time in a thermo-hygrostat adjusted to 25° C. and 60% by weight RH and then its moisture content and hardness were measured. In this case, the moisture content was calculated from the changes in weight before and after 24 hours of drying at 105° C. Also, hardness of the dough sheet was measured using TensiPresser (My Boy) manufactured by Takemoto Denki Co,. A cylindrical tube plunger (5 mm Φ) was used in the measurement, clearance was set to 0.05 mm and the maximum stress to maximum compression point (dyn/cm²) was defined as the hardness.

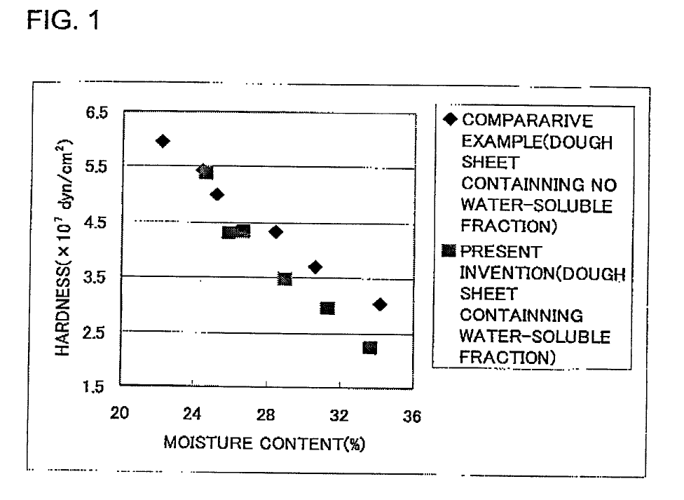

Results of the measurement are shown in FIG. 1. It can be seen from the drawing that, in comparison with the dough sheet to which the water-soluble fraction derived from soft wheat flour was not added, the fraction-added dough sheet has evidently small hardness value at the same moisture value and can keep its softness even when the moisture is reduced.

### EXAMPLE 4

Evaluation of the water-soluble fraction derived from hard wheat flour using gyoza:

The water-soluble fraction derived from hard wheat flour described in Example 2 (freeze-dried and then pulverized) was added in a amount of 0 or 15 parts by weight (0 or 10.8% by weight based on the skin weight) to 100 parts by weight of wheat flour (medium-strength flour), 1 part by weight of sodium chloride and 37.5 parts by weight of water and mixed for 10 minutes and then the mixture was made into a dough sheet using a noodle making machine. This was rolled and formed into a dough sheet thickness of 0.6 mm and then the ingredients (13 g/one gyoza) were packed therein to prepare gyoza samples. They were steamed for 5 minutes using a steamer, frozen at −40° C. for 1 hour in a quick freezer and then transferred into a refrigerator of −20° C. to carry out freeze storage for a predetermined period of time. After the storage, the frozen gyoza samples were thawed and cooked for about 2 minutes in a household microwave oven (500 W) in the presence of water in the system, and softness of the skin was evaluated by sensory test carried out by a panel of 12 skilled persons.

Sensory evaluation of the softness of skin was carried out by the five step evaluation of from 1 to 5 points with the point 5 being the highest point. In this case, the panel was told in advance to evaluate based on the following evaluation criteria. Results of the evaluation just after steaming and after 1 month of freezer storage at −20° C. are shown in Table 1.

<Evaluation criteria of the softness of skin portion of gyoza>

Point 5. . . Markedly soft and smooth.

Point 4. . . Softness can be felt clearly.

Point 3. . . Softness can be felt slightly.

Point 2. . . Softness can be felt barely.

Point 1. . . Hard, and softness cannot be felt.

TABLE 1

| | Evaluation points | | | | | | | | | | | | |
|---|---|---|---|---|---|---|---|---|---|---|---|---|---|
| Gyoza/panel | A | B | C | D | E | F | G | H | I | J | K | L | Av. |
| The invention (just after | 5 | 5 | 4 | 5 | 5 | 5 | 4 | 5 | 5 | 4 | 5 | 4 | 4.7 |
| steaming) | | | | | | | | | | | | | |
| Comparative example (just | 5 | 4 | 3 | 4 | 3 | 4 | 3 | 4 | 4 | 3 | 4 | 4 | 3.8 |
| after steaming) | | | | | | | | | | | | | |
| Inventive (after 1 month | 4 | 5 | 3 | 4 | 4 | 5 | 3 | 5 | 4 | 4 | 5 | 3 | 4.1 |
| storage at −20° C.) | | | | | | | | | | | | | |
| Comparative (after 1 | 3 | 2 | 1 | 2 | 1 | 2 | 1 | 2 | 2 | 1 | 2 | 2 | 1.8 |
| month storage at −20° C.) | | | | | | | | | | | | | |

Av: Average value

As shown in Table 1, in comparison with the gyoza prepared without adding the water-soluble fraction derived from hard wheat flour to the skin portion, the fraction-added gyoza scored fairly high evaluation points on the skin softness in both cases of just after steaming and after 1 month of storage at −20° C., thus confirming that softness of the skin can be maintained not only just after steaming but also after a prolonged period of freezer preservation by the addition of the water-soluble fraction of the invention to the skin portion.

As has been described in detail in the foregoing, the invention has rendered possibility to provide food in which deterioration of palatability in texture accompanied by the loss of moisture is prevented without exerting influences upon the original taste, flavor and palatability, by separating a water-soluble fraction having an equilibrium moisture content of from 10% by weight to 80% by weight at 25° C. and a glass transition moisture of from 1% by weight to 30% by weight at 25° C. from a cereal material, and adding the water-solvable fraction in a portion of foods e.g., processed food, where deterioration of palatability in texture occurs due to reduction of moisture during preservation and/or cooking, in an amount of from 0.2% by weight to 50% by weight of the total solid content of the portion.

While the invention has been described in detail and with reference to specific embodiments thereof, it will be apparent to one skilled in the art that various changes and modifications can be made therein without departing from the spirit and scope thereof.

This application is based on Japanese patent applications No. Hei. 11-358280 filed on Dec. 17, 1999, the entire contents thereof being hereby incorporated by reference.

What is claimed is:

1. A cereal flour dough sheet-derived food, which contains a cereal material-derived water-soluble fraction in a portion of food where deterioration of palpability in texture occurs, said fraction having an equilibrium moisture content of from 10% by weight to 80% by weight at 25° C. and a glass transition moisture of from 1% by weight to 30% by weight at 25° C., and
said fraction being contained in an amount of from 0.2% by weight to 50% by weight calculated as the solid content based on the total solid content of said portion.

2. The cereal flour dough sheet-derived food according to claim 1, wherein said cereal flour dough sheet-derived food is selected from thee group consisting of frozen food and chilled food.

3. The cereal flour dough sheet-derived food according to claim 1 or 2, wherein said cereal flour dough sheet-derived food is selected from the group consisting of gyoza (jiao-zi, a dumpling stuffed with minced meat), Shao-mai (Chinese-style steamed meat or shrimp dumpling), wonton (a Chinese flour dumpling with meat) and ravioli.

4. The cereal flour dough sheet-derived food according to claim 3 , wherein the portion of said food where deterioration of palatability in texture occurs is the skin portion of selected from the group consisting of gyoza, Shao-mai, wonton and ravioli.

5. A process for producing cereal flour dough sheet-derived food, which comprises preparing a dispersion by adding from the equivalent volume to 20 volumes of water to a cereal material and thoroughly stirring and mixing them, allowing the dispersion to stand at a temperature of 70° C. or less for a period of from 30 minutes to 48 hours, subsequently carrying out solid-liquid separation to obtain an aqueous solution containing a water-soluble fraction having an equilibrium moisture content of from 10% by weight to 80% by weight at 25° C. and a glass transition moisture of from 1% by weight to 30% by weight at 25° C., and then adding the water-soluble fraction of said aqueous solution in a portion of food where deterioration of palatability in texture occurs, in an amount of from 0.2% by weight to 50% by weight calculated as the solid content based on the total solid content of said portion.

6. The process for producing cereal flour dough sheet-derived food according to claim 5, wherein the water-soluble fraction of said aqueous solution is included in a portion where deterioration of palatability in texture occurs, directly as the state of aqueous solution containing said water-soluble fraction.

7. The process for producing cereal flour dough sheet-derived food according to claim 5, wherein said cereal flour dough sheet-derived food is selected from the group consisting of frozen food and chilled food.

8. The process for producing cereal flour dough sheet-derived food according to claim 6, wherein said cereal flour dough sheet-derived food is selected from the group consisting of frozen food and chilled food.

9. The process for producing cereal flour dough sheet-derived food according to any one of claims 5 to 8, wherein said cereal flour dough sheet-derived food is selected from the group consisting of gyoza, Shao-mai, wonton and ravioli.

10. The process for producing cereal flour dough sheet-derived food according to claim 9, wherein the portion of said food where deterioration of palatability in texture occurs is the skin portion of selected from the group consisting of gyoza, shao-mai, wonton and ravioli.
